(19) United States
(12) Patent Application Publication
(10) Pub. No.: US 2009/0322619 A1
(43) Pub. Date: Dec. 31, 2009

(54) PERFORMANCE IMPROVEMENT OF ANTENNAS

(76) Inventors: Jani Petri Juhani Ollikainen, Helsinki (FI); An-Ping Zhao, Beijing (CN); Jussi Olavi Rahola, Espoo (FI)

Correspondence Address: DITTHAVONG MORI & STEINER, P.C., 918 Prince St., Alexandria, VA, 22314, US

(21) Appl. No.: 12/146,595

(22) Filed: Jun. 26, 2008

(51) Int. Cl. H01Q 1/24; H01Q 1/48; H01P 11/00; H01Q 1/00

(52) U.S. Cl. 343/702; 343/846; 343/787; 29/600

(57) ABSTRACT

The present invention relates to an antenna arrangement, an adaptive system comprising such arrangement, a portable electronic device comprising such arrangement or adaptive system, a method of manufacturing such an arrangement, and a computer-readable storage medium encoded with instructions for performing such method. The antenna arrangement can comprise at least one antenna element (110) configured to supply a current, at least one ground plane element (120) configured to conduct the current, and at least one magnetic element (130) configured to influence at least a part of the current in order to modify an electrical length of the at least one ground plane element (120). It enables to increase the electrical length of a terminal chassis, which may increase the operation bandwidth of the antenna-chassis combination. This effect can be further increased when combining at least one slot and at least one magnetic element covering the same at least partially.

### FIELD OF THE INVENTION

The present invention relates to an antenna arrangement and a method of manufacturing such an antenna arrangement.

### BACKGROUND OF THE INVENTION

Impedance bandwidth and total efficiency of small unbalanced antennas used in today's portable electronic devices such as mobile phones, mobile terminals and the like depend strongly on the largest dimension (typically length) of a metal and/or conductive structure that acts as a ground plane for an antenna. Typically, this ground plane, which is often called metal chassis of a terminal, can be formed by ground layers of a printed circuit board (PCB) or printed wiring board (PWB) and/or other metal objects attached to the same, such as radio frequency (RF) shields.

However, when the length of the chassis is decreased below a certain size, e.g. 100 mm, it becomes difficult to design compact (internal) antennas that have sufficient impedance match and hence sufficiently large total efficiency to cover desired frequency ranges, such as both 850 MHz (824-894 MHz) and 900 MHz (880-960 MHz) cellular bands or even either one of them in case of mobile phones. The shorter the chassis length is, the more difficult it is to achieve the required impedance match and efficiency.

The theory behind the problem can be explained as follows for the exemplary case of a mobile terminal antenna. For example, at around 900 MHz, a combination of a typical mobile terminal antenna and a metal chassis can support two significant resonant wave modes, namely a resonant mode of the antenna and a resonant mode of the chassis. This is discussed in more detail in P. Vainikainen, J. Ollikainen, O. Kivekäs, and I. Kelander, “Resonator-based analysis of the mobile handset antenna and chassis”, IEEE Transactions on Antennas and Propagation, Vol. 50, No. 10, October 2002, pp. 1433-1444. Owing to its electrically small size, even the theoretical maximum radiation bandwidth of the isolated resonant mode of a typical internal mobile terminal antenna (which may have a size of e.g. 35 mm×25 mm×7 mm (width×length×height)) may be too small for communication systems operating near 1 GHz and below, such as GSM850, GSM900 and WCDMA850. On the other hand, the bandwidth of the resonant mode of the chassis (which may have a size of e.g. 40 mm×100 mm×1 mm (width×length×thickness)) may be sufficient for most systems.

Hence, by coupling the resonant mode of the antenna to that of the chassis, the bandwidth measured at an antenna feed can be increased considerably. This makes it possible to cover e.g. the GSM850 or GSM900 system bands or both of them with a small internal or external antenna. The bandwidth that can be measured at the antenna feed depends on the coupling between the resonant modes of the antenna and the chassis as well as the relative resonant frequencies of the resonant modes. The bandwidth of a mobile terminal antenna-chassis combination can be maximized by setting the resonant frequencies of the two mentioned modes equal and by optimizing (usually maximizing) the coupling between the modes. If the coupling is fixed, and the length (or largest dimension) of the chassis is decreased, its resonant frequency increases, which increases a frequency separation of the resonant modes. This causes the bandwidth to decrease rapidly. Ultimately, the bandwidth approaches that of the antenna mode alone when the chassis becomes very small and finally matches the size of the antenna.

It has been suggested in the above-mentioned document to increase the electrical length of the chassis by making slots in it or meandering it. In practice, making one or more slots in the PWB or chassis is difficult due to the other electronics, display, battery, etc. Making slots in the chassis may also increase specific absorption rate (SAR) values, especially at 850 MHz and 900 MHz.

### SUMMARY OF SOME EXAMPLES OF THE INVENTION

In an exemplary implementation an antenna arrangement can comprise: at least one antenna element configured to supply a current; at least one ground plane element configured to conduct the current; and at least one magnetic element configured to influence at least a part of the current in order to modify an electrical length of the at least one ground plane element.

The at least one magnetic element may be located on at least one side of the at least one ground plane element. It can be configured to extend from a top side of the at least one ground plane element to a bottom side thereof. The at least one magnetic element may be located near or at a position where it provides a noticeable modification of the electrical length of the at least one ground plane element.

The at least one magnetic element can be located near or at a position where the current has a maximal value. Further, it may be located at a position where the current has a value near or at a minimal value for a resonant mode of the at least one ground plane element and has a value near or at a maximal value for at least one further resonant mode of the at least one ground plane element. The at least one magnetic element can be located near or at a longitudinal center of the at least one ground plane element.

The at least one magnetic element may be substantially block-shaped or slab-shaped. It can be a tunable magnetic load and may be electrically reconfigurable.

The antenna arrangement may further comprise: at least one bypass element configured to bypass the at least one magnetic element and to conduct at least a part of the current. Moreover, it can further comprise: at least one switch element or varactor configured to control the at least a part of the current conducted by the at least one bypass element. In addition, the antenna arrangement may further comprise: at least one filter element configured to filter the at least a part of the current conducted by the at least one bypass element.

The at least one magnetic element can comprise a magnetic material having a relative permeability greater than 1 (μᵣ>1). It may comprise at least one of a lossless magnetic material and a low-loss magnetic material. Further, the at least one magnetic element can comprise at least one of a natural magnetic material, an artificial magnetic material, an electromagnetic bandgap material and a metamaterial with suitable characteristics.

The at least one ground plane element can comprise at least one slot extending in a substantially transverse direction of the at least one ground plane element. The at least one magnetic element may be configured to cover the at least one slot at least partially. Further, each of the at least one antenna element can comprise at least one feed element, and at least one of the at least one slot may comprise at least one feed element.

The antenna arrangement may further comprise: at least one first magnetic element located on a top side of the at least one ground plane element and extending in a substantially transverse direction of the at least one ground plane element; at least one second magnetic element located on a bottom side of the at least one ground plane element and extending in a substantially transverse direction of the at least one ground plane element; and a feed element located at one of the at least one first and second magnetic elements. The at least one of the at least one first and second magnetic elements can be shorter than a dimension of the at least one ground plane element in the transverse direction thereof, so that an uncovered portion of the at least one ground plane element acts as a short circuit between two portions of the at least one ground plane element separated by the at least one first and second magnetic elements, creating an impedance transformer into the feed element.

In another exemplary implementation an antenna arrangement may comprise: at least one antenna means for supplying a current; at least one ground plane means for conducting the current; and at least one magnetic means for influencing at least a part of the current in order to modify an electrical length of the at least one ground plane means.

A portable electronic device can comprise at least one antenna arrangement such as described above.

In an exemplary implementation an adaptive system may comprise: at least one antenna element configured to supply a current; at least one ground plane element configured to conduct the current; at least one magnetic element configured to influence at least a part of the current in order to modify an electrical length of the at least one ground plane element, wherein the at least one magnetic element is switchable or tunable; and at least one of a sensor circuitry configured to detect different use conditions or external loading, a control circuitry including a control processor, switch elements, tuning elements, and a biasing circuitry.

A portable electronic device can comprise: an adaptive system such as described above; a radio frequency control circuitry; and a link between the adaptive system and the radio frequency control circuitry, wherein the link is configured to get band switching information and/or to report information on external loading.

In an exemplary implementation a method of manufacturing an antenna arrangement may comprise: providing at least one antenna element configured to supply a current; providing at least one ground plane element configured to conduct the current; and providing at least one magnetic element configured to influence at least a part of the current in order to modify an electrical length of the at least one ground plane element.

In a further exemplary implementation a computer-readable storage medium can be encoded with instructions that, when executed by a computer, perform: providing at least one antenna element configured to supply a current; providing at least one ground plane element configured to conduct the current; and providing at least one magnetic element configured to influence at least a part of the current in order to modify an electrical length of the at least one ground plane element.

Accordingly, by placing natural or artificial low-loss magnetic material on the ground plane or chassis of the antenna arrangement of e.g. a portable electronic device, the electrical length of the chassis can be increased (resonant frequency decreased) and matched or set closer to that of the antenna arrangement, which may increase the operation bandwidth (both impedance and efficiency bandwidth) of the antenna-chassis combination. This measure, in turn, can lead to a considerable increase in bandwidth. This effect can be further increased when combining at least one slot and at least one magnetic element covering the same at least partially. The increase of the electrical length enables a performance improvement of small antennas used in fairly small radio devices such as mobile phones or mobile terminals. Thus, the antenna arrangement is useful for such small radio devices.

The proposed solution is very simple to use and does not require making any slots or holes to the circuit board or chassis. Hence, signal lines inside the circuit board are not affected.

Moreover, the proposed solution works for any resonant antenna (e.g. patch antenna, inverted-F antenna (IFA), planar inverted-F antenna (PIFA), helix antenna, loop antenna, monopole antenna, dielectric resonator antenna (DRA) etc.) arranged on a non-optimally sized finite ground plane. Therefore, it can be implemented in any device which requires a compact antenna.

Additionally, the proposed solution allows the use of separate tuning elements for different frequency bands. Further, the antenna arrangement can be made electrically reconfigurable.

As opposed to conventional ferrites, low-loss magnetic materials do not deteriorate the efficiency of the terminal or electronic device accommodating the antenna arrangement. Even fairly lossy material (magnetic tanδ=0.1) can be utilized. When used for increasing the electrical length of a terminal, magnetic material can have a more than 10 times higher loss tangent than when used as an antenna substrate.

Further advantageous modifications are defined in the dependent claims.

### BRIEF DESCRIPTION OF THE DRAWINGS

In the following, the present invention will be described on the basis of embodiments with reference to the accompanying drawings in which:

FIG. 1 shows a top view of an exemplary antenna arrangement according to first and second embodiments;

FIG. 2 shows a schematic perspective view of the exemplary antenna arrangement according to the first and second embodiments;

FIG. 3 shows a diagram illustrating examples of frequency responses of a reflection coefficient at different values of permeability for the antenna arrangement according to the first and second embodiments;

FIG. 4 shows a diagram illustrating an exemplary mobile phone according to the first and second embodiments in a talk position;

FIG. 5 shows a diagram illustrating an example of a bandwidth improvement achieved in the talk position with the antenna arrangement according to the first and second embodiments;

FIG. 6 shows schematic diagrams illustrating an effect of a slot and effects of magnetic elements with relative permeabilities 10 and 70 on a current distribution occurring on a monoblock ground plane element;

FIG. 7 shows a diagram illustrating an example of a current distribution on a monoblock ground plane element showing a dipole-like longitudinal resonant mode at about 1 GHz;

FIG. 8 shows a diagram illustrating a normalized current magnitude along the longitudinal edge of the monoblock ground plane element of FIG. 7 for the fundamental mode (e.g. 1 GHz) as well as the first two higher order resonant modes (here 2 GHz and 3 GHz);

FIG. 9 shows a top view of an exemplary antenna arrangement according to a third embodiment;

FIG. 10 shows a graph illustrating a simulated impedance bandwidth potential around 900 MHz;

FIG. 11 shows a graph illustrating a simulated impedance bandwidth potential around 1800 MHz;

FIG. 12 shows a schematic flow chart of an exemplary manufacturing procedure according to the first and second embodiments;

FIG. 13 shows a schematic block diagram of a software-based implementation of the first and second embodiments; and

FIG. 14 shows a schematic exploded view of a portable electronic device comprising an antenna arrangement or adaptive system according to one of the embodiments.

### DESCRIPTION OF EMBODIMENTS

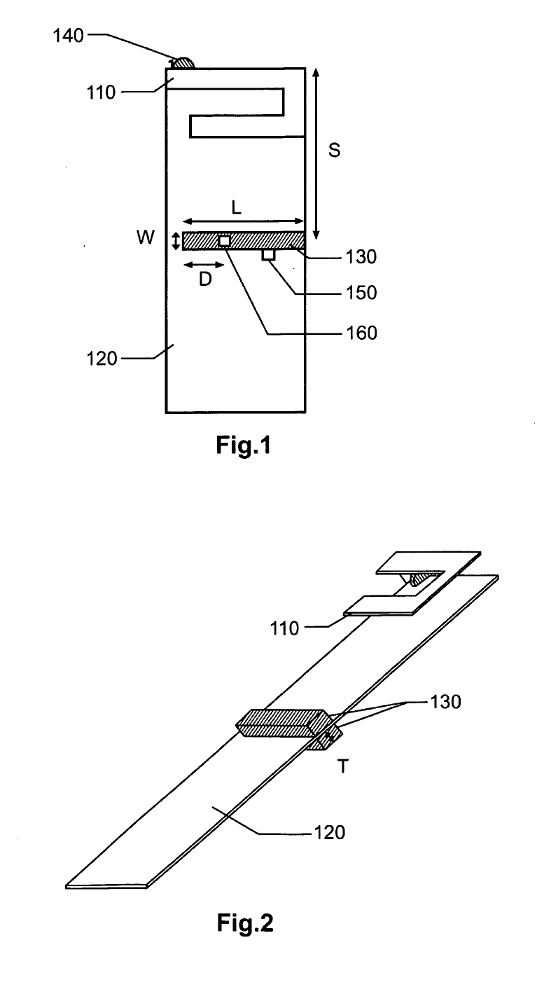

FIG. 1 shows a top view of an exemplary antenna arrangement according to first and second embodiments. FIG. 2 shows a schematic perspective view of the exemplary antenna arrangement according to the first and second embodiments.

The antenna arrangement, construction or assembly of FIG. 1 and FIG. 2 can comprise at least one antenna or antenna element 110, at least one chassis, ground plane or ground plane element 120 and at least one magnetic block or magnetic element 130. While in FIG. 1 and FIG. 2 only one antenna element 110, one ground plane element 120 and two magnetic elements 130 are illustrated and the following description may at least partially relate only to these elements, there can be a plurality of antenna elements 110 and ground plane elements 120 as well as more than two magnetic elements 130 in the antenna arrangement. Further, there may be only a single magnetic element 130 wrapped around the ground plane element 120. In this case, there can be two small gaps at the sides of the at least one ground plane element 120 so as to allow to wrap the magnetic element 130 around the same, wherein the magnetic element 130 may be some kind of film made of magnetic material. The at least one magnetic element 130 can comprise magnetic material having a relative permeability that is e.g. greater than 1 (μᵣ>1), greater than 2 (μᵣ>2), greater than 5 (μᵣ>5) etc. FIG. 1 and FIG. 2 as well as the following description are intended to be merely exemplary and should not be construed as limiting in any way.

The at least one antenna element 110 can be a resonant antenna such as a patch antenna, an inverted-F antenna (IFA), a planar inverted-F antenna (PIFA), a helix antenna, a loop antenna, a monopole antenna, a dielectric resonator antenna (DRA) etc. The at least one ground plane element 120 may be a metal and/or conductive chassis of a terminal like e.g. a portable electronic device such as a mobile phone or handset. It can be formed by ground layers of a printed circuit board (PCB) or printed wiring board (PWB) and/or other metal and/or conductive objects attached to the same, such as e.g. radio frequency (RF) shields. The at least one magnetic element 130 can be substantially block-shaped or slab-shaped. For example, it may be a small block or thin slab of natural magnetic material. The at least one magnetic element 130 can be placed at least on one side of the at least one ground plane element 120 and extend in a substantially transverse direction thereof. It may force currents on the at least one ground plane element 120 to flow along a longer path, thereby increasing its electrical length as well as the electrical length of a terminal such as e.g. a mobile phone including the at least one ground plane element 120.

The at least one magnetic element 130 can be used simultaneously for controlling the electrical length of a chassis and as a substrate for any antenna. This may be achieved if the at least one magnetic element 130 is large and sufficiently low-loss enough.

The at least one ground plane element 120 shown in FIG. 1 and FIG. 2 may have e.g. a size of 40 mm×100 mm×1 mm. The height of the at least one antenna element 110 can be e.g. 6 mm. The size of the at least one magnetic element 130 may be W×L×T, wherein this can apply on each side of the at least one ground plane element 120. The location of the at least one magnetic element 130 may be described by S as shown in FIG. 1.

As apparent from FIG. 2, the at least one magnetic element 130 can be located on a top side and a bottom side of the ground plane element 120 in the depicted exemplary antenna arrangement. That is, a first magnetic element may be located on the top side of the ground plane element 120 and a second magnetic element can be located on the bottom side thereof in this example. However, the at least one magnetic element 130 can also extend from the top side of the ground plane element 120 to the bottom side thereof, i.e. be wrapped around the ground plane element 120 on at least one of the left and right sides of the ground plane element 120.

By placing one or more magnetic elements of natural low-loss magnetic material (relative permeability μᵣ>1) in suitable locations on the metal chassis or ground plane element 120 of a mobile terminal, such as shown in FIG. 1 and FIG. 2, the electrical length of the ground plane element 120 can be increased (resonant frequency decreased) and matched or set closer to that of the antenna. The electrical length of the chassis may be increased because the blocks of magnetic material can force the chassis currents to go around them (longer distance). This may increase the operation bandwidth (both impedance and efficiency bandwidth) of the antenna-chassis combination.

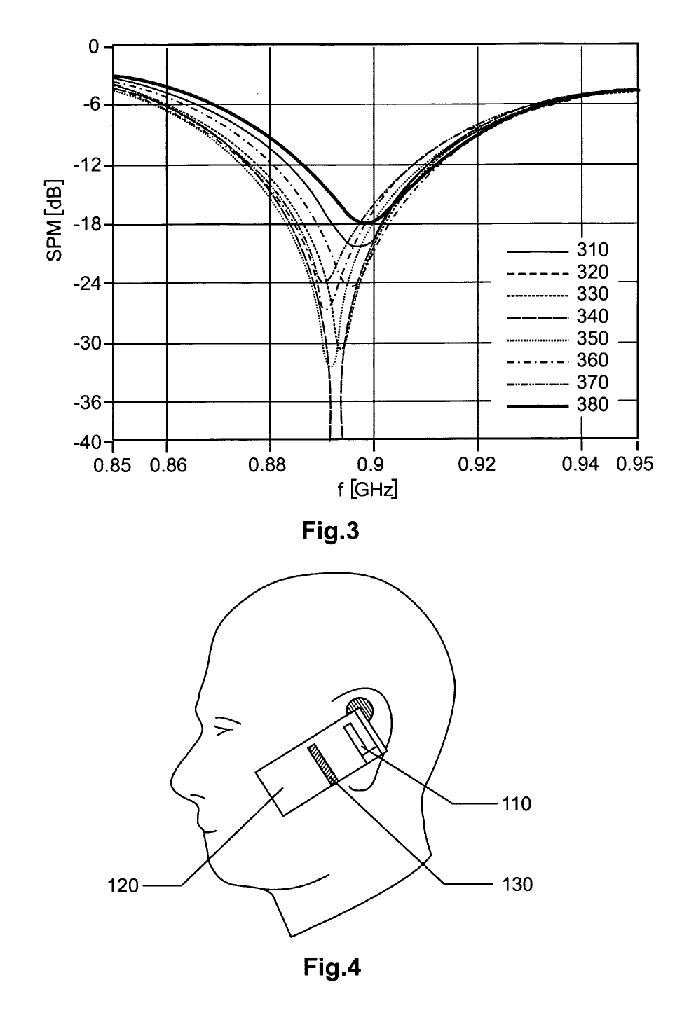

FIG. 3 shows a diagram illustrating examples of frequency responses of a reflection coefficient at different values of permeability for the antenna arrangement according to the first and second embodiments. S₁₁ is compared for different values of μᵣ (μᵣ=10 . . . 70), where dimensions and location of the at least one magnetic element 130 are fixed at L=35 mm, T=3 mm, W=5 mm, and S=50 mm. On the horizontal axis the frequency in GHz (f [GHz]) is indicated, and on the vertical axis the magnitude of the S-parameter in dB (SPM [dB]) is indicated. Reference numerals 310 to 370 denote curves for μᵣ=10, μᵣ=20, . . . , and μᵣ=70. A reference numeral 380 denotes a curve of a reference case without a magnetic element (μᵣ=1). An increase of bandwidth with unoptimized magnetic elements can be seen clearly. This is illustrated in Table 1 showing the increase of bandwidth in the cases presented in FIG. 3.

TABLE 1

| VS = 50 mm, | | | | |
|---|---|---|---|---|
| T = 3 mm, | High | | | |
| W = 5 mm, | frequency | Low frequency | Bandwidth | |
| L = 35 mm | (MHz) | (MHz) | (MHz) | Improvement |
| Reference case | 935 | 869 | 66 | 0% |
| μᵣ = 10 | 935 | 867 | 68 | 4.4% |
| μᵣ = 20 | 936 | 864 | 72 | 9.2% |
| μᵣ = 30 | 936 | 862 | 74 | 13.4% |
| μᵣ = 40 | 936 | 860 | 76 | 16.6% |
| μᵣ = 50 | 937 | 858 | 79 | 20.0% |
| μᵣ = 60 | 937 | 857 | 80 | 22.6% |
| μᵣ = 70 | 937 | 855 | 82 | 25.2% |

Table 1 indicates the bandwidth improvement for different values of μᵣ. Results for an antenna arrangement with a lossless magnetic material block are illustrated. As shown in Table 1, the bandwidth improvement increases with μᵣ. The reference case represents results for an original PIFA antenna, i.e., without a magnetic material block.

A further increase of the bandwidth can be achieved by making the magnetic elements as wide as the terminal chassis or slightly wider and by optimizing the coupling of the antenna feed to the antenna (the antenna feed position).

A similar improvement may also be achieved in a talk position of a mobile phone comprising the exemplary antenna arrangement according to the first embodiment. FIG. 4 shows a diagram illustrating an exemplary mobile phone according to the first and second embodiments in a talk position. In the depicted case the ground plane element 120 can be e.g. 7 mm away from the head (tilted case only). The magnetic material may be lossless, low-loss or slightly lossy, wherein the loss tangent can be e.g. tanδ=0.02.

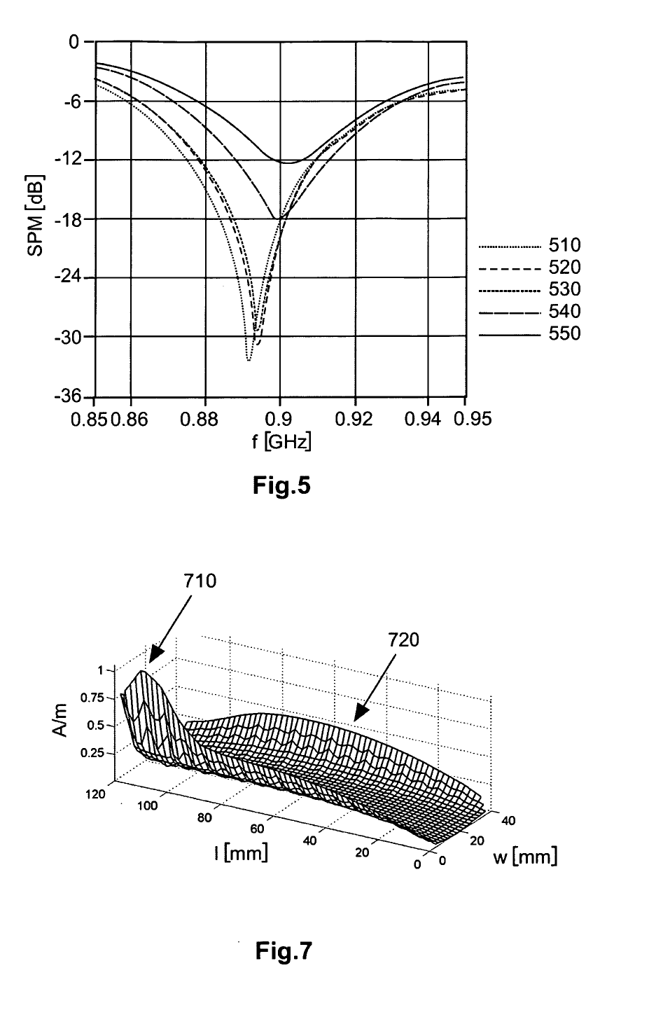

FIG. 5 shows a diagram illustrating an example of a bandwidth improvement achieved in the talk position with the antenna arrangement according to the first and second embodiments. S₁₁ is compared for different cases, where dimensions and location of the at least one magnetic element 130 are again fixed at L=35 mm, T=3 mm, W=5 mm, and S=50 mm. On the horizontal axis the frequency in GHz is indicated, and on the vertical axis the magnitude of the S-parameter in dB is indicated. A reference numeral 510 denotes a curve for a lossless magnetic material with μᵣ=50 and free space, i.e. no head and/or hand close to the mobile phone. A reference numeral 520 denotes a curve for a low-loss magnetic material with μᵣ=50 and a location of the mobile phone near to the head. A reference numeral 530 denotes a curve for a lossless magnetic material with μᵣ=50 and a location of the mobile phone near to the head. A reference numeral 540 denotes a curve of a reference case without a magnetic element and in free space. A reference numeral 550 denotes a curve of a reference case without a magnetic element and with a location of the mobile phone near to the head. As apparent from a comparison of the curves 540, 550 for the reference cases and the curves 520, 530 for low-loss or lossless magnetic material being present, a bandwidth improvement can also be achieved in the talk position.

As shown in FIG. 5, the bandwidth improvement is maintained also in the talk position. It can be seen that S₁₁ does not change much when the magnetic material is changed from the lossless case to the low-loss case.

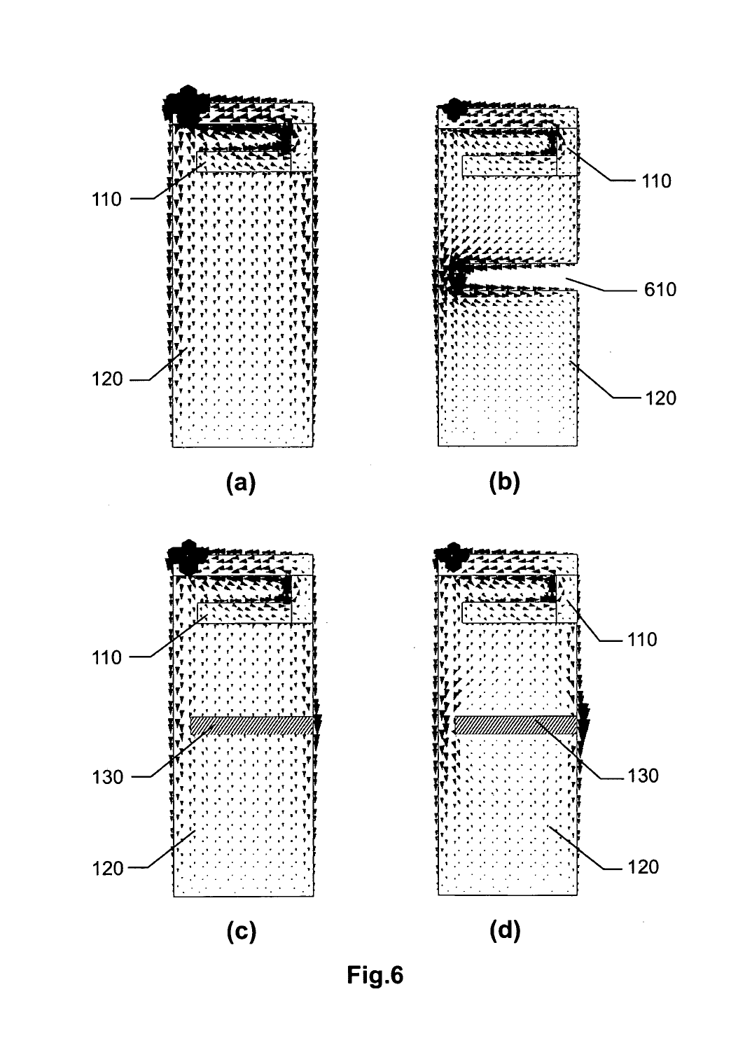

The effect of the at least one magnetic element 130 is similar to that achieved by providing the ground plane element 120 with a slot. FIG. 6 shows schematic diagrams illustrating an effect of a slot and effects of magnetic elements with relative permeabilities 10 and 70 on a current distribution occurring on a ground plane element. FIG. 6(a) illustrates a current distribution occurring on a reference ground plane element 120, i.e. without a slot or magnetic element. FIG. 6(b) illustrates a current distribution on a ground plane element 120 provided with a slot 610 having dimensions of e.g. 8 mm×35 mm. FIG. 6(c) illustrates a current distribution on a ground plane element 120 with magnetic elements 130 located on both sides of the same and having dimensions of e.g. L=5 mm, W=35 mm and T=3 mm as well as a relative permeability of μᵣ=10. FIG. 6(d) illustrates a current distribution on a ground plane element 120 with magnetic elements 130 located on both sides of the same and having dimensions of e.g. L=5 mm, W=35 mm and T=3 mm as well as a relative permeability of μᵣ=70.

FIG. 6 shows current distributions on a 40 mm×100 mm monoblock ground plane element at 900 MHz in four cases. As illustrated in FIG. 6, part of the current can “leak” through the load, but despite that a sufficient inductive loading effect may be obtained to increase the electrical length of the ground plane element. The effect of inductive loading may be strongest at the current maximum. Hence, an optimal position for the at least one magnetic element 130 can be near the longitudinal center of a monoblock ground plane element at 900 MHz. The effect of the magnetic material may get stronger as the relative permeability μᵣ increases.

In the cases depicted in FIG. 6(c) and FIG. 6(d), the current can escape around the at least one magnetic element 130 along the right edge of the ground plane element 120 because the at least one magnetic element 130 does not go around the ground plane element 120. A similar effect may also be achieved by placing a block of electromagnetic bandgap material (EBG) at the same location.

The magnetic material can have the strongest effect on the electrical length of the ground plane element 120 when it is placed at the current maximum of a relevant resonant mode. FIG. 7 shows a diagram illustrating an example of a current distribution on a monoblock ground plane element showing a dipole-like longitudinal resonant mode at about 1 GHz. The chassis can have a length l and a width w. The vertical axis of the diagram shown in FIG. 7 indicates a normalized current magnitude A/m. An arrow 710 points at an area of a resonant mode of the antenna element 110, and an arrow 720 points at an area of a resonant mode of the ground plane element 120.

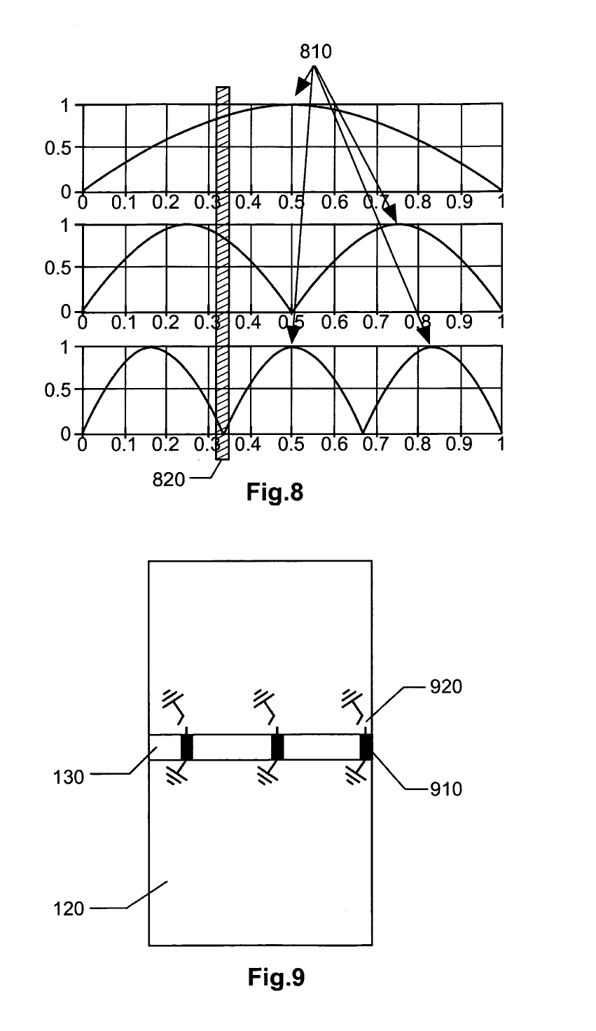

FIG. 8 shows a diagram illustrating a normalized current magnitude along the longitudinal edge of the ground plane element of FIG. 7 for the fundamental mode (e.g. 1 GHz) as well as the first two higher order resonant modes (here 2 GHz and 3 GHz). FIG. 8 shows the most effective locations for the magnetic elements 130. Arrows 810 denote these most effective locations. In addition, it can be observed that if a magnetic element 130 is placed near to a current maximum of e.g. two modes, but at a current minimum of a third mode, the frequency separation of the modes can be controlled. A reference numeral 820 denotes a placement that may tune e.g. the resonant modes at 1 GHz and 2 GHz but not 3 GHz. With typical ground plane element dimensions the higher order modes may not be exact harmonics of the fundamental mode, but the principles illustrated in FIG. 8 can also apply in real cases.

Thus, FIG. 7 and FIG. 8 show an example of how the placement of magnetic elements at different locations on a mobile terminal chassis can be used to control a fundamental resonant mode and higher order resonant modes of the chassis, i.e. how magnetic material may be used to control the frequency separation of the resonant modes of the chassis. This can allow moving the chassis resonances to the used communication bands for novel mobile terminal form factors that would not have a natural resonance at those frequencies.

A second embodiment is based on the first embodiment. It differs from the same in that the at least one magnetic element 130 can comprise artificial magnetic material, electromagnetic bandgap material (EBG) or metamaterial with suitable characteristics. Besides of that fact, an antenna arrangement according to the second embodiment corresponds to the antenna arrangement of the first embodiment. That is, it may comprise at least one antenna or antenna element 110, at least one chassis, ground plane or ground plane element 120 and at least one magnetic block or magnetic element 130 as shown in FIG. 1 and FIG. 2. The at least one magnetic element 130 can be placed at least on one side of the at least one ground plane element 120 so that it may force currents on the at least one ground plane element 120 to flow along a longer path, thereby increasing the electrical length of the at least one ground plane element 120.

For example, materials that have been used to isolate two antennas can be used for the above described purpose, i.e. for the magnetic element 130. A magnetic element of artificial magnetic material may have e.g. similar dimensions as the magnetic element 130 of natural magnetic material as shown in FIG. 1. The main requirement for such a material is that it should present a high impedance for the currents flowing on the surface of the metal chassis, i.e. the ground plane element 120. The impedance should differ clearly from that of surrounding materials. The frequency response of the impedance of the artificial material can either be constant or have a low-pass, high-pass, band-pass, or band-stop type of characteristic. Such a characteristic may be utilized in multiband or multiradio terminals. For example, if the material is of high-pass type, it can block the current at the low frequencies such as e.g. 900 MHz, thereby increasing the electrical length of the terminal. At higher frequencies, where a shorter electrical length is desired, the material may become transparent and no longer block the current, making the chassis more optimal e.g. for 2 GHz systems.

An antenna arrangement according to the second embodiment can have a construction and provide effects similar to those described for the first embodiment. Thus, a more detailed discussion of the same is omitted here.

FIG. 9 shows a top view of an exemplary antenna arrangement according to a third embodiment. The third embodiment is based on the first and second embodiments. That is, the antenna arrangement may comprise at least one antenna or antenna element 110, at least one chassis, ground plane or ground plane element 120 and at least one magnetic block or magnetic element 130. A magnetic element 130 can be a block or slab of natural or artificial magnetic material or EBG material.

In addition to the elements describe above, the antenna arrangement according to the third embodiment may comprise at least one bypass element 910 and at least one switch element 920. The bypass element 910 can be e.g. a metallic strip that is connected to the chassis or ground plane element 120 at one end, then goes around the magnetic element 130, and may be connected to the ground plane element 120 again at the other end with the switch element 920. The switch element 920 can be a switch or a variable reactance (varactor). If a varactor represents a low reactance, it may effectively be a short circuit and act like a closed switch. When the varactor represents a high impedance, it can effectively be an open circuit and act like an open switch. The varactor may have any value between a low reactance (short circuit) and a high reactance (open circuit). It can be tuned continuously or with discrete steps. The use of a varactor in connection with a bypass element 910 enables to control how much current is allowed to bypass the magnetic element 130 and, thus, how strong the effect of the magnetic element 130 will be. This may be called a tunable magnetic load. The switch element 920 may be one of many types of switch elements, for example, bipolar junction transistors (BJTs), field effect transistors (FETs), micro electro mechanical (MEM) switches, diodes, etc, and is therefore not limited by the examples herein.

There can be multiple of such combinations of a bypass element 910 and a switch element or varactor 920 for controlling the effectivity of the magnetic element 130. FIG. 9 shows an example of a tunable magnetic element 130 with three switchable bypassing strips. The switch element 920 may be replaced with a filter element like e.g. a filter to make at least one of the bypassing strips band selective. Such a filter element can consist of at least one inductor or at least one capacitor or a combination of at least one inductor and at least one capacitor. The components may be lumped or distributed. Alternatively, the filter element can be implemented with any other RF and microwave technology.

In the multiradio context, it can be advantageous to be able to bypass the blocks so that they do not affect the current distribution at certain bands. In the following, this is described in further detail.

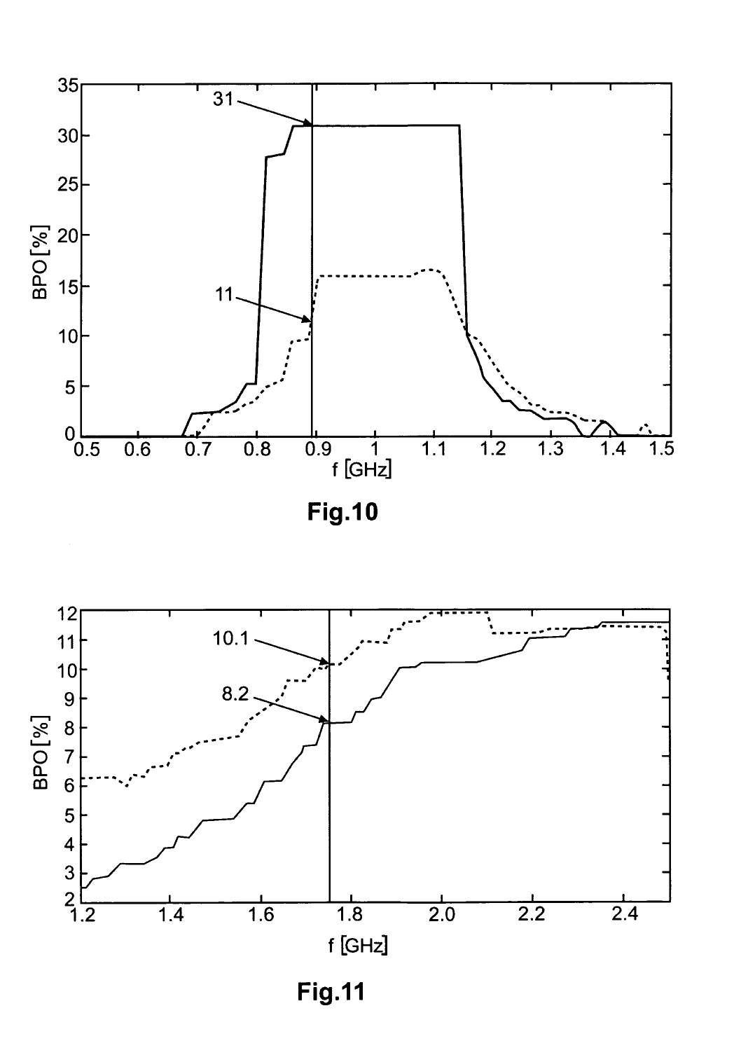

FIG. 10 shows a graph illustrating a simulated impedance bandwidth potential (BPO) around 900 MHz. Bandwidth potential is the largest relative impedance bandwidth that can be achieved at each center frequency given on the horizontal axis. In the present application, impedance bandwidth is defined as the frequency range in which the return loss is 6 dB or greater (Lᵣₑₜₙ≧6 dB). This is used also in the calculation of the bandwidth potential.

In FIG. 10, a continuous line indicates BPO for a case without bypass elements 910 or with open switch elements 920. A dashed line indicates a case with fixed bypass elements 910 or closed switch elements 920. On the horizontal axis the frequency in GHz is indicated, and on the vertical axis the bandwidth potential (optimized) in percent (BPO [%]) is indicated.

FIG. 11 shows a graph illustrating a simulated impedance bandwidth potential around 1800 MHz. A continuous line indicates a case without bypass elements 910 or with open switch elements 920. A dashed line indicates a case with fixed bypass elements 910 or closed switch elements 920. On the horizontal axis the frequency in GHz is indicated, and on the vertical axis the bandwidth potential (optimized) in percent is indicated.

As apparent from FIG. 10, when the at least one switch element 920 is open or no bypass element 910 is present, the high bandwidth potential can start already at the lower end of the low band (824-960 MHz). Closing the at least one switch element 920 may make the chassis look shorter and reduce the bandwidth potential at the lower end of the low band, but it can improve the efficiency at 900 MHz. In addition, closing the at least one switch element 920 may improve the bandwidth potential at the low end of the high band (1710-2170 MHz) as shown in FIG. 11.

When the at least one bypass element 910 is used, surface current can flow dominantly through the at least one bypass element 910. Thus, the effective increase of the chassis inductance (lengthened current path) may be reduced. The weakened material effect can be seen as a decreased bandwidth potential (or shift to higher frequencies) in FIG. 10. For example, at a certain frequency close to 900 MHz the bandwidth potential amounts to 11% with the at least one bypass element 910 (at least one switch element 920 closed), while it amounts to 31% without the at least one bypass element 910 (at least one switch element 920 open). This is illustrated by two arrows in FIG. 10. However, if the material is not totally lossless, the radiation efficiency can increase as most of the edge currents flow through the at least one bypass element 910 and less current flows “through” the material. This is due to the fact that current tends to flow through a path with the lowest impedance.

At 1800 MHz the bandwidth potential is higher with the at least one bypass element 910. For example, at a certain frequency around 1800 MHz the bandwidth potential amounts to 10.1% with the at least one bypass element 910 (at least one switch element 920 closed), while it amounts to 8.2% without the at least one bypass element 910 (at least one switch element 920 open). This is illustrated by two arrows in FIG. 11. Material losses are smaller in this case, because at 1800 MHz the chassis wavemodes do not contribute to radiation as strongly as at 900 MHz (maximum surface current amplitude is smaller).

According to a fourth embodiment based on any one of the first to third embodiments, the at least one magnetic element 130 can be combined with a slot. That is, the at least one ground plane element 120 can further comprise at least one slot, which may extend in a substantially transverse direction thereof. The at least one slot may be covered at least partially by the at least one magnetic element 130 and, thus, is not shown in FIG. 1 and FIG. 2. An exemplary slot 610 is illustrated in FIG. 6(a), where no magnetic element covering the slot 610 is depicted.

Such a combination of magnetic material and at least one slot 610 can lead to a significant increase in operation bandwidth (nearly 200%). The same result may be achieved with just a slot. However, with magnetic material the mentioned increase can be achieved using a considerably smaller slot size.

The at least one slot that is at least partly covered by the magnetic material may also double as a slot antenna in the antenna arrangement. In this case, the at least one antenna element 110 can comprise at least one feed element 140 as shown in FIG. 1. Further, the at least one slot can comprise at least one feed element 150 as shown in FIG. 1. That is, the antenna arrangement may comprise at least one antenna element 110 and at least one ground plane element 120 for the at least one antenna element 110, wherein each antenna element can have at least one feed element 140, wherein the at least one ground plane element 120 may have at least one slot, and wherein at least one of the slots can be partially covered with at least one magnetic element 130 and have at least one feed element 150. That is, while only one feed element 140 and one feed element 150 are depicted in FIG. 1, a plurality of each of these elements may be present.

According to a fifth embodiment based on any one of the first to fourth embodiments, the at least one magnetic element 130 can effectively cut the at least one ground plane element 120 into two separate or isolated halves, provided that it has a sufficiently high permeability. That is, the at least one ground plane element 120 may be electrically (effectively) separated into two e.g. equally sized pieces. The separating magnetic elements 130 can form something that is nearly equivalent to an open slot/gap between the two pieces. For example, two 50 mm×5 mm×1 mm blocks of low-loss magnetic material having a sufficiently high relative permeability may be placed on both of the top and bottom sides of a ground plane element 120 having e.g. a size of 40 mm×100 mm×1 mm. That is, they can be placed as shown in FIG. 1 and FIG. 2, except that the length L of the blocks may be equal to or larger than the width of the ground plane element 120, i.e. amount to at least 40 mm in the present example.

If a feed (signal source) is placed between the two pieces, the antenna arrangement can effectively function as a simple dipole having a certain input impedance that (for the basic longitudinal dipole mode) does not depend much on the transverse position of the feed between the pieces. For example, a feed element 160 may be located over or at one of first and second magnetic elements 130 placed on the top and bottom sides of the ground plane element 120. With such configuration, the two separate or isolated halves may be driven against each other in a dipole-like configuration.

Alternatively, if the length L of at least one of the first and second magnetic elements 130 is shorter than the width of the ground plane element 120, the uncovered part of the ground plane element 120 can act as a short circuit creating an impedance transformer into the dipole feed and allowing further impedance control without a matching circuit. That is, if the two pieces are connected to each other with a short circuit at one end of at least one magnetic element 130, then the input impedance may be lower close to the short circuit and increase as the feed element 160 is moved from the short circuit towards the non-shorted end of the magnetic element 130. Thus, the greater a distance D between the short circuit and the feed element 160 is, the greater is the input impedance. As changing the distance between the short circuit and the feed, placed over or at a magnetic element, can change the impedance of the antenna configuration, the combination is called an impedance transformer.

According to a sixth embodiment based on any one of the first to fifth embodiments, the antenna arrangement can be part of an adaptive system. That is, the adaptive system may comprise at least one antenna element 110 for supplying a current, at least one ground plane element 120 for conducting the current, at least one magnetic element 130 for influencing at least a part of the current in order to modify an electrical length of the at least one ground plane element 120, wherein the at least one magnetic element 130 is switchable or tunable, and at least one of a sensor circuitry configured to detect different use conditions or external loading, a control circuitry including a control processor, switch elements, tuning elements, and a biasing circuitry. In addition, the adaptive system can have a link to a RF control circuitry of a terminal such as e.g. a mobile phone for getting band switching information and/or for reporting e.g. information on an external loading e.g. by a head or hand for decision making. The adaptive system enables to make the antenna arrangement electrically reconfigurable.

The loading of the head and/or the hand of a user can affect the electrical length of the ground plane element 120. If tunable magnetic elements 130 are used to optimize the electrical length of the ground plane element 120 in free space, the electrical length may not be optimal anymore when the phone is held in the hand in a talk position or web browsing position. Various types of sensors may be applied to detect the presence or absence of the user's head or hand. Such sensors can be connected to a processing unit for making a decision to change the states of the switchable or tunable magnetic elements 130 in order to reoptimize the electrical length of the ground plane element 120, i.e. a terminal including the same. Further, a single sensor may also directly control a tunable magnetic element 130.

In a multiradio system such as e.g. a mobile phone for operating at multiple frequency bands, the optimal electrical length of the ground plane element 120 is different for each band. Reconfigurable or tunable magnetic elements 130 can be used to optimize the electrical length for a respective band. A processor for controlling the operation band of the mobile phone may control the tunable magnetic elements 130 directly with bias signals. Alternatively, it can provide the band information to a further control block for controlling the tunable magnetic elements 130.

The control of the tunable magnetic elements 130 may also be based on information whether a fold or slide phone is open or closed, or any mode change information of a multi-operation-mode terminal.

Furthermore, the adaptive system can have e.g. an antenna impedance mismatch monitoring circuit for providing mismatch information to the processor or control block, which in turn may change the states of the tunable magnetic elements 130 in order to minimize the impedance mismatch and maximize the performance.

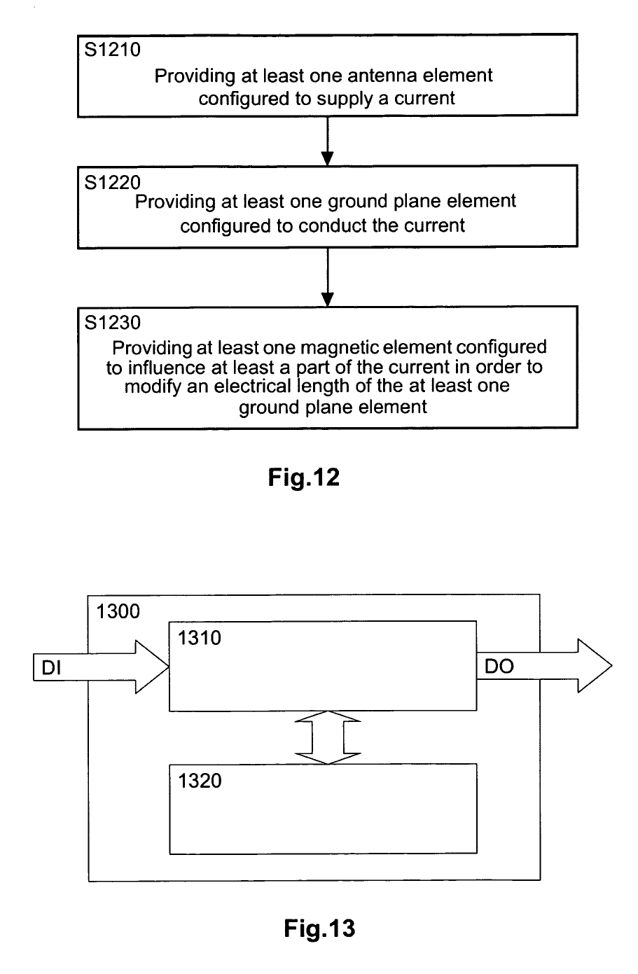

FIG. 12 shows a schematic flow chart of an exemplary manufacturing procedure according to the first and second embodiments. In a step S1210, at least one antenna element configured to supply a current is provided. In a step S1220, at least one ground plane element configured to conduct the current is provided. In a step S1230, at least one magnetic element configured to influence at least a part of the current in order to modify an electrical length of the at least one ground plane element is provided.

FIG. 13 shows a schematic block diagram of a software-based implementation of the first and second embodiments. The required functionalities can be implemented in a processing unit 1300, which may be any processor or computer device with a control unit 1310 that performs control based on software routines of a control program stored in a memory 1320. The control program may also be stored separately on a computer-readable medium. Program code instructions can be fetched from the memory 1320 and loaded into the control unit 1310 of the processing unit 1300 in order to perform the processing steps of the above functionalities of the embodiments, which may be implemented as the abovementioned software routines. The processing steps can be performed on the basis of input data DI and may generate output data DO. The input data DI may correspond e.g. to construction information indicating the construction of an antenna arrangement. The output data DO can correspond e.g. to instructions for a computer aided manufacturing (CAM) system used to manufacture the antenna arrangement.

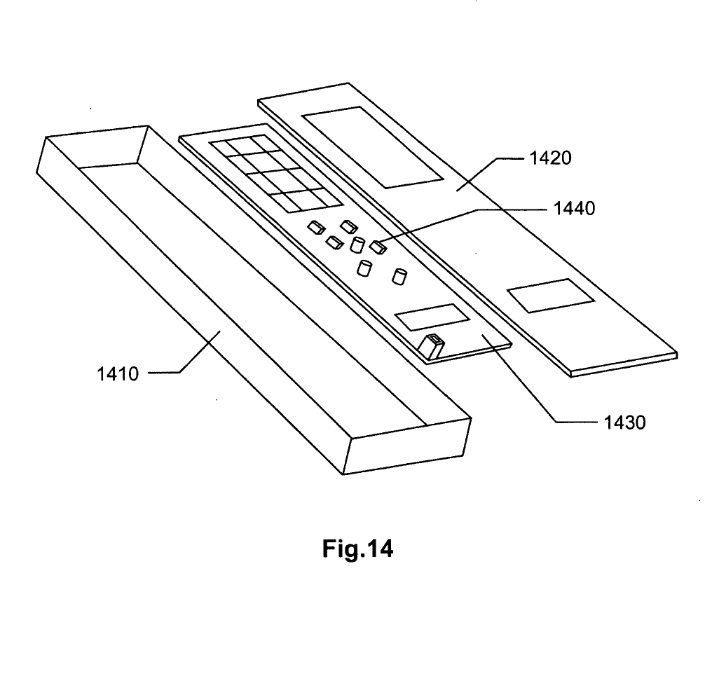

FIG. 14 shows a schematic exploded view of a portable electronic device comprising an antenna arrangement or adaptive system according to one of the embodiments. The portable electronic device such as e.g. a mobile phone can comprise a back cover 1410 and a front cover 1420, which in their assembled state form a housing of the portable electronic device. Furthermore, a PCB or PWB 1430 may be inserted into the housing in the assembled state where the front cover 1420 is fixed onto the back cover 1410. The PCB or PWB 1430 can comprise circuitry 1440 such as e.g. the circuitry described in connection with the sixth embodiment. Further, the PCB or PWB 1430 is shown with a schematic keypad and display and may correspond to the at least one ground plane element 120. That is, the portable electronic device as shown in FIG. 14 can comprise an antenna arrangement or adaptive system as described above.

The at least one magnetic element 130 may be integrated to the back cover 1410 and/or the front cover 1420. That is, the at least one magnetic element 130 can be integrated to plastic covers or metal covers of a portable electronic device such as a mobile terminal. On the other hand, the at least one magnetic element 130 may also be integrated to e.g. a plastic chassis of such device. Magnetic elements 130 do not have to be separate components but can be an integral part of a mechanical assembly.

The above described embodiments enable to increase the electrical length of a metal chassis in terminals where it is needed. It may be applied to improve an antenna performance in physically too short (e.g. between 75 mm and 110 mm long) monoblock phones. Another application are phones with unconventional form factors. For example, the antenna performance of fold and slide phones changes between the open and closed states. When e.g. a small fold phone having dimensions of e.g. 40 mm×75 mm is closed, the ground plane of the phone can be too short for the antenna to operate properly. By using a magnetic element, the electrical length of the ground plane can be increased when the fold phone is closed. This may increase the antenna performance in the closed position and decrease the performance difference between the open and closed positions.

The described magnetic elements further enable to shift locations of SAR maximums. Hence, it is also possible to use such devices to control the SAR. The current distribution on the chassis can be modified with lossless or low-loss magnetic material.

In summary, the present invention relates to an antenna arrangement, an adaptive system comprising such arrangement, a portable electronic device comprising such arrangement or adaptive system, a method of manufacturing such an arrangement, and a computer-readable storage medium encoded with instructions for performing such method. The antenna arrangement can comprise at least one antenna element 110 configured to supply a current, at least one ground plane element 120 configured to conduct the current, and at least one magnetic element 130 configured to influence at least a part of the current in order to modify an electrical length of the at least one ground plane element 120. It enables to increase the electrical length of a terminal chassis, which may increase the operation bandwidth of the antenna-chassis combination. This effect can be further increased when combining at least one slot and at least one magnetic element covering the same at least partially.

It is to be noted that the present invention is not restricted to the above described embodiments but can be implemented in connection with any electrically fairly small radio device, such as a mobile phone or mobile terminal, in order to improve the performance of small antennas used in these small radio devices. At lower frequencies than the ones used as examples in the present application, even physically larger objects, such as laptop computers or even cars, can be electrically fairly small. The embodiments may thus vary within the scope of the attached claims.

The invention can also be implemented in accordance with the following aspects.

According to a first aspect, an antenna arrangement can comprise: at least one antenna means for supplying a current; at least one ground plane means for conducting the current; and at least one magnetic means for influencing at least a part of the current in order to modify an electrical length of the at least one ground plane means.

According to a second aspect, in the antenna arrangement according to the first aspect, the at least one magnetic means may be located on at least one side of the at least one ground plane means.

According to a third aspect, in the antenna arrangement according to the first or second aspect, the at least one magnetic means can be configured to extend from a top side of the at least one ground plane means to a bottom side thereof.

According to a fourth aspect, in the antenna arrangement according to any one of the preceding aspects, the at least one magnetic means may be located near or at a position where it provides a noticeable modification of the electrical length of the at least one ground plane means.

According to a fifth aspect, in the antenna arrangement according to any one of the preceding aspects, the at least one magnetic means can be located near or at a position where the current has a maximal value.

According to a sixth aspect, in the antenna arrangement according to any one of the preceding aspects, the at least one magnetic means may be located at a position where the current has a value near or at a minimal value for a resonant mode of the at least one ground plane means and has a value near or at a maximal value for at least one further resonant mode of the at least one ground plane means.

According to a seventh aspect, in the antenna arrangement according to any one of the preceding aspects, the at least one magnetic means can be located near or at a longitudinal center of the at least one ground plane means.

According to an eighth aspect, in the antenna arrangement according to any one of the preceding aspects, the at least one magnetic means may be substantially block-shaped or slab-shaped.

According to a ninth aspect, in the antenna arrangement according to any one of the preceding aspects, the at least one magnetic means can be a tunable magnetic load.

According to a tenth aspect, in the antenna arrangement according to any one of the preceding aspects, the at least one magnetic means may be electrically reconfigurable.

According to an eleventh aspect, the antenna arrangement according to any one of the preceding aspects can comprise: at least one bypass means for bypassing the at least one magnetic means and conducting at least a part of the current.

According to a twelfth aspect, the antenna arrangement according to the eleventh aspect may comprise: at least one switch means or varactor for controlling the at least a part of the current conducted by the at least one bypass means.

According to a thirteenth aspect, the antenna arrangement according to the eleventh aspect can comprise: at least one filter means for filtering the at least a part of the current conducted by the at least one bypass means.

According to a fourteenth aspect, in the antenna arrangement according to any one of the preceding aspects, the at least one magnetic means may comprise a magnetic material having a relative permeability greater than 1.

According to a fifteenth aspect, in the antenna arrangement according to any one of the preceding aspects, the at least one magnetic means can comprise at least one of a lossless magnetic material and a low-loss magnetic material.

According to a sixteenth aspect, in the antenna arrangement according to any one of the preceding aspects, the at least one magnetic means may comprise at least one of a natural magnetic material, an artificial magnetic material, an electromagnetic bandgap material and a metamaterial with suitable characteristics.

According to a seventeenth aspect, in the antenna arrangement according to any one of the preceding aspects, the at least one ground plane means can comprise at least one slot extending in a substantially transverse direction of the at least one ground plane means.

According to an eighteenth aspect, in the antenna arrangement according to the seventeenth aspect, the at least one magnetic means may be configured to cover the at least one slot at least partially.

According to a nineteenth aspect, in the antenna arrangement according to the seventeenth or eighteenth aspect, each of the at least one antenna means can comprise at least one feed means, and at least one of the at least one slot may comprise at least one feed means.

According to a twentieth aspect, the antenna arrangement according to any one of the preceding aspects can comprise: at least one first magnetic means located on a top side of the at least one ground plane means and extending in a substantially transverse direction of the at least one ground plane means; at least one second magnetic means located on a bottom side of the at least one ground plane means and extending in a substantially transverse direction of the at least one ground plane means; and a feed means located at one of the at least one first and second magnetic means.

According to a twenty-first aspect, in the antenna arrangement according to the twentieth aspect, at least one of the at least one first and second magnetic means may be shorter than a dimension of the at least one ground plane means in the transverse direction thereof, so that an uncovered portion of the at least one ground plane means acts as a short circuit between two portions of the at least one ground plane means separated by the at least one first and second magnetic means, creating an impedance transformer into the feed means.

According to a twenty-second aspect, a portable electronic device can comprise at least one antenna arrangement according to any one of the preceding aspects.

According to a twenty-third aspect, the portable electronic device according to the twenty-second aspect may comprise: at least one cover; and at least one chassis, wherein the at least one magnetic means can be configured to be an integral part of at least one of the at least one cover and the at least one chassis.

According to a twenty-fourth aspect, an adaptive system may comprise: at least one antenna arrangement according to any one of the preceding aspects, wherein the at least one magnetic means is switchable or tunable; and at least one of sensor means for detecting different use conditions or external loading, control means, switch means, tuning means, and biasing means.

According to a twenty-fifth aspect, a portable electronic device can comprise: an adaptive system according to the twenty-fourth aspect; radio frequency control means; and a link between the adaptive system and the radio frequency control means, wherein the link is configured to get band switching information and/or to report information on external loading.

According to a twenty-sixth aspect, a method of manufacturing an antenna arrangement may comprise: providing at least one antenna means for supplying a current; providing at least one ground plane means for conducting the current; and providing at least one magnetic means for influencing at least a part of the current in order to modify an electrical length of the at least one ground plane means.

According to a twenty-seventh aspect, a computer program product can comprise code means for performing the steps of the method according to the twenty-sixth aspect when run on a computer device.

1. An antenna arrangement comprising:
at least one antenna element configured to supply a current;
at least one ground plane element configured to conduct said current; and
at least one magnetic element configured to influence at least a part of said current in order to modify an electrical length of said at least one ground plane element.

2. The antenna arrangement according to claim 1, wherein said at least one magnetic element is located on at least one side of said at least one ground plane element.

3. The antenna arrangement according to claim 1, wherein said at least one magnetic element is configured to extend from a top side of said at least one ground plane element to a bottom side thereof.

4. The antenna arrangement according to claim 1, wherein said at least one magnetic element is located near or at a position where it provides a noticeable modification of said electrical length of said at least one ground plane element.

5. The antenna arrangement according to claim 1, wherein said at least one magnetic element is located near or at a position where said current has a maximal value.

6. The antenna arrangement according to claim 1, wherein said at least one magnetic element is located at a position where said current has a value near or at a minimal value for a resonant mode of said at least one ground plane element and has a value near or at a maximal value for at least one further resonant mode of said at least one ground plane element.

7. The antenna arrangement according to claim 1, wherein said at least one magnetic element is located near or at a longitudinal center of said at least one ground plane element.

8. The antenna arrangement according to claim 1, wherein said at least one magnetic element is substantially block-shaped or slab-shaped.

9. The antenna arrangement according to claim 1, wherein said at least one magnetic element is a tunable magnetic load.

10. The antenna arrangement according to claim 1, wherein said at least one magnetic element is electrically reconfigurable.

11. The antenna arrangement according to claim 1, further comprising:
at least one bypass element configured to bypass said at least one magnetic element and to conduct at least a part of said current.

12. The antenna arrangement according to claim 11, further comprising:
at least one switch element or varactor configured to control said at least a part of said current conducted by said at least one bypass element.

13. The antenna arrangement according to claim 11, further comprising:
at least one filter element configured to filter said at least a part of said current conducted by said at least one bypass element.

14. The antenna arrangement according to claim 1, wherein said at least one magnetic element comprises a magnetic material having a relative permeability greater than 1.

15. The antenna arrangement according to claim 1, wherein said at least one magnetic element comprises at least one of a lossless magnetic material and a low-loss magnetic material.

16. The antenna arrangement according to claim 1, wherein said at least one magnetic element comprises at least one of a natural magnetic material, an artificial magnetic material, an electromagnetic bandgap material and a metamaterial with suitable characteristics.

17. The antenna arrangement according to claim 1, wherein said at least one ground plane element comprises at least one slot extending in a substantially transverse direction of said at least one ground plane element.

18. The antenna arrangement according to claim 17, wherein said at least one magnetic element is configured to cover said at least one slot at least partially.

19. The antenna arrangement according to claim 18, wherein each of said at least one antenna element comprises at least one feed element, and at least one of said at least one slot comprises at least one feed element.

20. The antenna arrangement according to claim 1, further comprising:
at least one first magnetic element located on a top side of said at least one ground plane element and extending in a substantially transverse direction of said at least one ground plane element;
at least one second magnetic element located on a bottom side of said at least one ground plane element and extending in a substantially transverse direction of said at least one ground plane element; and
a feed element located at one of said at least one first and second magnetic elements.

21. The antenna arrangement according to claim 20, wherein at least one of said at least one first and second magnetic elements is shorter than a dimension of said at least one ground plane element in said transverse direction thereof, so that an uncovered portion of said at least one ground plane element acts as a short circuit between two portions of said at least one ground plane element separated by said at least one first and second magnetic elements, creating an impedance transformer into said feed element.

22. An antenna arrangement comprising:
at least one antenna means for supplying a current;
at least one ground plane means for conducting said current; and
at least one magnetic means for influencing at least a part of said current in order to modify an electrical length of said at least one ground plane means.

23. A portable electronic device comprising at least one antenna arrangement according to claim 1.

24. The portable electronic device according to claim 23, further comprising:
at least one cover; and
at least one chassis,
wherein said at least one magnetic element is configured to be an integral part of at least one of said at least one cover and said at least one chassis.

25. An adaptive system comprising:
at least one antenna element configured to supply a current;
at least one ground plane element configured to conduct said current;
at least one magnetic element configured to influence at least a part of said current in order to modify an electrical length of said at least one ground plane element, wherein said at least one magnetic element is switchable or tunable; and
at least one of a sensor circuitry configured to detect different use conditions or external loading, a control circuitry including a control processor, switch elements, tuning elements, and a biasing circuitry.

26. A portable electronic device comprising:
an adaptive system according to claim 25;
a radio frequency control circuitry; and
a link between said adaptive system and said radio frequency control circuitry, wherein said link is configured to get band switching information and/or to report information on external loading.

27. A method of manufacturing an antenna arrangement, said method comprising:
providing at least one antenna element configured to supply a current;
providing at least one ground plane element configured to conduct said current; and
providing at least one magnetic element configured to influence at least a part of said current in order to modify an electrical length of said at least one ground plane element.

28. A computer-readable storage medium encoded with instructions that, when executed by a computer, perform:
providing at least one antenna element configured to supply a current;
providing at least one ground plane element configured to conduct said current; and
providing at least one magnetic element configured to influence at least a part of said current in order to modify an electrical length of said at least one ground plane element.
